(19) United States
(12) Patent Application Publication
(10) Pub. No.: US 2006/0200548 A1
(43) Pub. Date: Sep. 7, 2006

(54) Automation engine and method for providing an abstraction layer

(75) Inventor: Weidong Min, Ottawa (CA)

Correspondence Address: VOLPE AND KOENIG, P.C., UNITED PLAZA, SUITE 1600, 30 SOUTH 17TH STREET, PHILADELPHIA, PA, 19103, US

(73) Assignee: N-Able Technologies International, Inc., Dover, DE (US)

(21) Appl. No.: 11/070,703

(22) Filed: Mar. 2, 2005

(51) Int. Cl. G06F 15/173

(52) U.S. Cl. 709/224

(57) ABSTRACT

A system for monitoring constituents of a network is disclosed. The system includes an automation engine in communication with the constituent. Code written in a service description language contains extractable information to permit the automation engine to obtain raw operation data nascent from the constituent. The system also includes at least one module for processing the code and providing the extractable information to the automation engine.

### RELATED APPLICATION

The following commonly-owned, co-pending patent application is related and is incorporated herein by reference: Ser. No. 11/043,396, filed Jan. 26, 2005, entitled “APPARATUS AND METHOD FOR MONITORING NETWORK RESOURCES” (hereinafter “the Gilbert application”).

### FIELD OF THE INVENTION

The present invention relates to network monitoring architectures and, in particular, to monitoring automation engines and methods for providing an abstraction layer.

### BACKGROUND OF THE INVENTION

In the context of network monitoring systems, metrics being collected are protocol specific. Also, sometimes the lower level protocols used to collect the metrics are very complicated or vendor specific. A review of prior art network monitoring systems reveals that the typical way to collect different metrics is to develop different modules. Those wishing to improve on these types of network monitoring systems observe that there is a need to reduce software development man hours.

U.S. Pat. No. 6,725,233 of Froyd et al. discloses a generic interface for system and application management. An Internal Manager defines an abstract interface and a framework gluing internal applications (at a command line interface) to a system. When the Internal Manager is used to interface with SNMP, most of the SNMP code is automatically generated by an agent software. This patent does not describe software designed to extract operation data from network devices.

U.S. Pat. No. 6,732,153 of Jakobson et al. discloses a system and apparatus, including a parsing knowledge structure (called a Message Class Grammar or MCG) containing a set of pre-calculated parsing sequences for an active network element. In the patent, it is stated that MCG is a structure of declarative specifications that describes “what” to parse rather than “how” to parse. A network architecture, which is described in Jakobson et al., includes managed network elements that supply raw message (event) streams. The raw messages proceed to a message parsing service, and the parsed messages proceed to an event correlation service. Also, an MCG editor and a graphical user interface are disclosed. The MCG output of these are represented in XML.

U.S. Pat. No. 6,721,286 of Williams et al. discloses a method and apparatus permitting communications through the use of generic instructions. The patent makes reference to a Hewlett-Packard product called JetSend™. JetSend enabled devices (e.g. printers, scanners) can address each other directly over a bi-directional transport using unique addressing. The layers that comprise the JetSend protocol are Interaction Policies, an Interaction Protocol, a Session Protocol and a Reliable Message Transport Protocol.

Japanese patent reference JP 02230449 A of Igarashi discloses a matrix control system for a communication control program. Within the environment of the matrix control system, a software mechanism facilitating the elimination of dependence on protocol procedure includes a matrix analyzer processing part and a matrix table. The matrix analyzer processing part and the matrix table are independent of associated processing modules, which are dependent on a control procedure. The disclosed software purportedly permits integrated and universal control of a matrix which does not depend on each communication control procedure.

### SUMMARY OF THE INVENTION

According to one example of the invention, a system for monitoring at least one constituent of a network is provided. The system includes an automation engine in communication with the constituent. Code written in a service description language contains extractable information to permit the automation engine to obtain raw operation data nascent from the constituent. The system also includes at least one module for processing the code and providing the extractable information to the automation engine.

According to another example of the invention, a method for obtaining operation data includes the steps of:
(1) retrieving code written in a service description language;
(2) extracting information from the code;
(3) generating executable instructions from the information, the instructions used for obtaining raw operation data nascent from at least one network constituent; and
(4) obtaining the raw data.

According to another example of the invention, a method for altering raw operation data nascent from a network constituent is provided. The method includes the steps of:
(1) retrieving code written in a service description language;
(2) extracting information from the code; and
(3) formatting the raw operation data into formatted service data, the information used in directing the formatting.

According to another example of the invention, an article of manufacture for a network monitoring system includes at least one processor readable carrier. The carrier includes executable instructions adapted for extracting information from code written in a service description language. Software means defines an automation engine. The automation engine is adapted for using the information to format raw operation data of at least one network constituent, obtained by a component of the monitoring system, into formatted service data.

Advantageously, an automation engine parses grammar and then accordingly collects metrics in a generic way, thereby avoiding the need to write software code for new metrics.

The automation engine can include a dynamic link library (DLL) so that block(s) of the same library code can be shared between several tasks.

### BRIEF DESCRIPTION OF THE DRAWINGS

These and other advantages of the invention will become apparent upon reading the following detailed description and upon referring to the drawings in which:—

FIG. 1 is a simplified diagram of a network architecture within which an embodiment of the present invention can be implemented;

FIG. 2 is a relationship diagram illustrating subsystems within an agent or probe architecture according to an embodiment of the present invention;

FIG. 3 is a relationship diagram illustrating an automation engine according to an embodiment of the present invention; and

FIG. 4 is a flow diagram of an example automation engine method for scan detail and recipe processing.

While the invention will be described in conjunction with illustrated embodiments, it will be understood that it is not intended to limit the invention to such embodiments. On the contrary, it is intended to cover all alternatives, modifications and equivalents as may be included within the spirit and scope of the invention as defined by the appended claims.

### DETAILED DESCRIPTION OF THE PREFERRED EMBODIMENTS

In the following description, similar features in the drawings may have been given the same reference numeral or similar reference numerals. Arrow heads of connector lines in the drawings indicate the flow of information and/or data in at least the direction of the arrow head.

One skilled in the art of software programming will appreciate that the term automation engine can have different meanings depending upon the context in which the term is used; however one possible definition of automation engine is a core piece of software present for the purposes of automation.

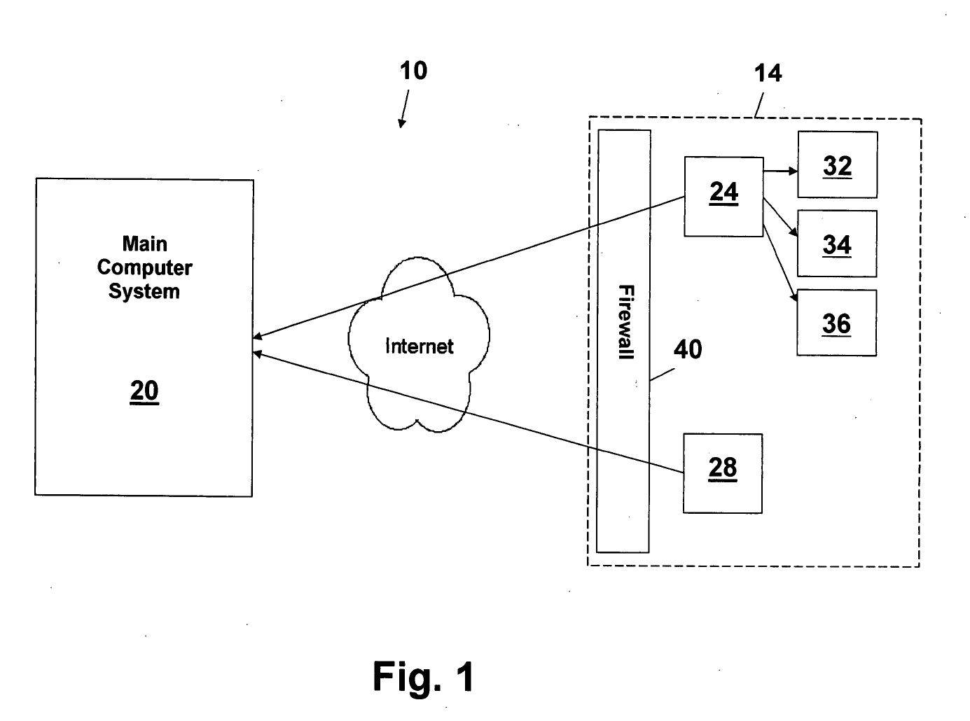

A network architecture 10 is illustrated in FIG. 1. In this Figure, computer network 14 can be located at a location different from a main computer system 20 (i.e. the computer system 20 is in a remote management location). Although only one client network 14 is illustrated, it will be appreciated that alternative network architectures could include any number of networks similar to the network 14.

Within the network 14 are one or more probes 24, and one or more agents 28. A computer platform can comprise the agent 28. In one embodiment, an appliance can comprise probe 24. The appliance can be added as a node to the network 14 during installation of the network monitoring software and hardware. The agents 28 can also be added during the installation.

The probe 24 and the agent 28 can monitor constituents within the network 14 using various protocols, including standard protocols such as Simple Network Management Protocol (SNMP) and Windows Management Instrumentation (WMI). It will be appreciated that Microsoft Windows™ platforms such as Windows 2000™, Windows XP™ and Windows ME™ can be monitored using a WMI probe, wherein the probe is external to the device having the platform.

In one possible network monitoring system within the network architecture 10, each of the probe 24 and the agent 28 load one or modules which gather operation data from the network constituents. The module(s) scan a device/service combination, and metrics are returned. For example, the probe 24 can obtain operation data from monitored network constituents such as switch/router 32, a printer 34 and a server/workstation 36. It will be understood that network constituents can include more than physical stand alone devices on the network. For example, a hard disk on a computer could be a network constituent, and so too could a file stored on a computer-readable medium.

Metrics obtained from the modules loaded on the probe 24 and the agent 28 are transmitted to the remote computer system 20. Specifically, the probe 24 or the agent 28 originates the connection with the remote computer system 20 in order to go through firewalls (e.g. firewall 40). Thus, the probe 24 and the agent 28 are also data forwarders. It will be understood that a network monitoring system could be constructed in which other components could function as data forwarders.

Data collected by the probe 24 and the agent 28 is transferred to the remote computer system 20 via simple object access protocol (SOAP) messages; however, it will be appreciated that this particular type of Extensible Markup Language (XML) protocol is not the only type of protocol that could be used to transmit the collected data.

This exemplary network monitoring system will preferably be designed to provide a variety of functions, one such functions being to provide intelligently processed information in relation to services. In implementing the design of the network monitoring system, a service description language can be used to describe the elements of a service. This can include describing the way to configure a service to the user interface (and letting the module know what data it is supported to be collecting), describing what the data looks like, and describing how to interpret the data once it has been collected.

A service description language is described in the Gilbert application mentioned previously. The software disclosed in the Gilbert application allows a network monitoring software suite or software program to provide definitions of services to be monitored. After the step of defining what services are to be monitored, the software suite can collect specific metrics from targeted devices under surveillance.

Code written in a service description language is important for obtaining operation data, but it is also important for related software-implemented methods such as altering raw operation data nascent from the monitored network constituents. Referring to FIG. 1, the code written in the service description language can be retrieved from a database in the computer system 20; however one skilled in the art will appreciate that the code need not be stored in the remote management location. For example, the code could also be stored at a server on the LAN.

In one embodiment, matrix information can be extracted from the code after it is retrieved from the database. The matrix information can be used to generate executable instructions for obtaining the raw operation data. The matrix information can also be used for a considerable number of other purposes, such as for formatting the raw operation data into formatted service data.

A matrix grammar can thus be used to provide an abstraction between the network monitoring software suite's service definition and any underlying protocols used to collect the metrics. The matrix grammar can define what to be monitored, how to poll data, and how to process data on an agent/probe side. The matrix grammar can also define what properties are to be collected, methods of polling data, and recipes about which properties to be returned. The information forms the basis of input and output formats for the automation engine. The information also instructs the engine, which is in communication with one or more monitored network constituents, what to do and how.

In one embodiment, the matrix grammar and monitoring automation engine are consistent with Common Information Model (CIM) and one of its instances, Windows Management Instrumentation (WMI). In this manner, a universal interface between network monitoring software and CIM/WMI is provided.

Agent or Probe Architecture

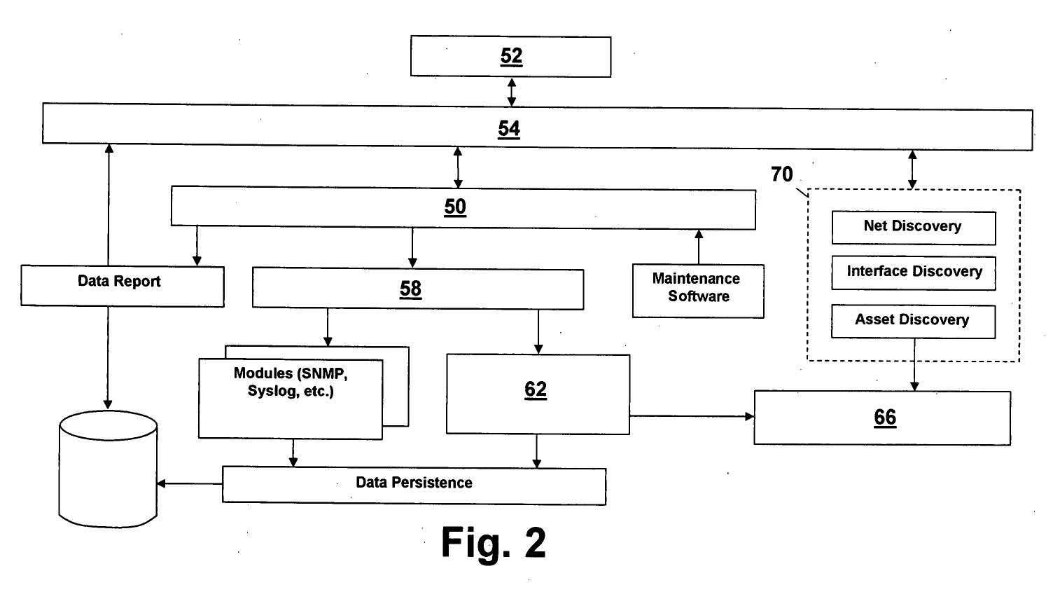

Subsystems and modules within an agent or probe architecture are shown in the relationship diagram of FIG. 2. One skilled in the art of software engineering will appreciate that a variety of different subsystems or modules besides those illustrated can be added to or replace portions of the illustrated architecture without departing from the spirit and scope of the invention.

In the illustrated architecture, WMI related service information is passed to an agent or probe controller 50. In particular, the service information originates from a main computer system 52 (which typically includes a server at the remote management location). A communication layer 54 exists between the controller 50 and the computer system 52.

The controller 50 passes the information to a task schedule component 58. The task schedule component 58 in turn passes universal service information to a universal WMI module 62. In one embodiment, the module 62 is a DLL.

The module 62 facilitates the defining of a particular feature as a particular WMI matrix to be saved in a data management system (DMS) located at the remote management location. When a new feature needs to be added, a new WMI matrix can be created and put into a DMS database. It will be understood that parameters passed by the DMS can include the WMI matrix information, the scan detail information, the internet protocol address of the monitored computer, etc.

In the illustrated architecture, the WMI module 62 extracts matrix information and calls Matrix DLL 66 (monitoring automation engine) to collect data. In one embodiment, the Matrix DLL 66 has a number of components and classes including an RPN module.

The data returned from the automation engine are organized in a universal format of service data. Also, the formatted service data are returned to the computer system 52 through an agent or probe data report component. Data persistence means can be employed to ensure the formatted service data is not lost before being returned to the computer system 52.

Stand-alone discovery applications 70 are also shown in FIG. 2. An application for discovering assets (Asset Discovery) is preferably released together with a probe for Windows™. This application uses the Matrix DLL 66 to discover hardware and software assets within an Internet Protocol (IP) range in a Windows™ domain (e.g. 192.168.20.*). The assets can include information of hard drive, disk, CPU, software installed, services running on machines, etc.

The other two illustrated discovery applications do not use the Matrix DLL 66. An application for discovering Internet devices (Net Discovery) is preferably released together with a probe for Linux™. This application detects accessible Internet devices within an IP range in a domain, as well as some of the properties of the devices. An application for discovering network interface information (Interface Discovery) is also preferably released together with a probe for Linux™. This application detects network interface information of network devices based on SNMP technologies.

Interface with CIM/WMI

In one embodiment, there is a WMI interface or a CIM interface between the called Matrix DLL 66 and the source of the raw operation data. One possible interface is IWbemServices.

IWbemServices is a WMI interface, and is used by clients to access WBEM (Web-Based Enterprise Management) services. It contains the following methods to fetch data from remote machines:
ExecQuery
ExecQueryAsync
ExecMethod
ExecMethodAsync
GetObject
GetObjectAsync

The ExecQuery method is used to execute a query to retrieve objects, which are available through the returned enumerator. All query results are returned through the enumerator as IEnumWbemClassObject. The developer of both IEnumWbemClassObject and IWbemServices is Microsoft Corporation.

The query uses WMI Query Language (WQL) to get information. The following is an example of how the query will do a job for a generic WMI class.

Select FreeSpace, Size, Name from Win32_LogicalDisk where DriveType=3

The results will be extracted from the enumerator based on the data type that is set in the matrix.

In order to get data related to particular network constituents, the WMI matrices need to be designed and then the matrices are interpreted into different WQL. What needs to be prepared is the WMI class name, parameters to be queried, and there is little (if any) coding work. This makes the module universal and saves developing work.

Features monitoring can be covered by a large number of WMI classes, six of which are:
Win32_Processor
Win32_LogicalDisk
Win32_PageFile
Win32_PageFileUsage
Win32_PerfRawData_PerfOS_Memory
Win32_Process

The developer of the above six WMI classes is Microsoft Corporation. Taking Win32_Process as another example, the following WQL obtains process information.

Select ProcessId, ExecutablePath, Name, KernelModeTime, UserModeTime from Win32_Process

Feature Monitoring can also be covered by various non-standard WMI classes which are consistent with CIM/WMI. Various software companies besides Microsoft Corporation are continually developing non-Standard WMI classes. Thus, the module 62 is universal, extensible and scalable.

Automation Engine

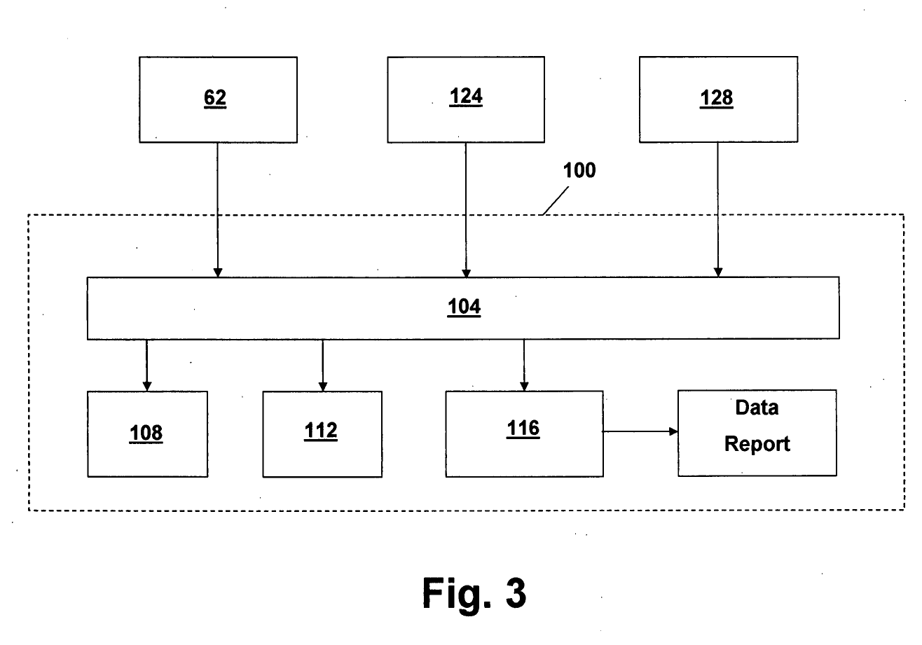

An automation engine 100 is illustrated in the relationship diagram of FIG. 3, and it will be understood that the arrow heads of the connector lines in this diagram indicate the flow of control and invoking information. The automation engine 100 includes a Matrix DLL controller 104 and three major components. The three major components are matrix analyzer 108, data collector 112 and recipe processor 116.

The matrix analyzer component 108 analyzes and interprets matrix grammar. It processes matrix code, forms necessary information for data collection according to different grammar, and then uses different solutions accordingly to collect data and do some initial processing. In other words, it interprets matrix grammar and forms instructions to execute the data collector component 112 to collect data.

The data collector component 112 is CIM/WMI based and makes use of Distributed Component Object Model (DCOM), WMI and CIM technologies to collect data locally or from remote devices.

The recipe processor component 116 processes scan details and handles data to be returned. Not only can variables generated by the data collector component 112 be returned directly, but also the initial data from the component 112 can be processed through mathematical and logic operations.

Recipes can be in Reverse Polish Notation (RPN) format (this type of format is discussed in a subsequent portion of this application). The final data is preferably returned in a universal way and flexible to fit into a favorite format of other applications. Flexible integration with outside applications is possible.

Relationship arrows are shown between three possible integration solutions and the automation engine 100. The automation engine 100 is integrated into the network monitoring system through the universal WMI module 62. The module 62 fetches WMI matrix details information from the DMS. It calls the WMI matrix DLL and returns results to the DMS in a universal format. The automation engine 100 can also be integrated with one or more stand-alone applications 124 (or agent modules). Possible stand-alone applications include asset discovery applications.

Matrix details can be defined from the DMS. Alternatively, the matrix details could be defined by third party applications, or even hard-coded. The returned results from the Matrix DLL are in a universal format.

The automation engine 100 can also be integrated with a WMI testing tool 128. Matrix details are read from files or a user interface. The results are saved in a file or displayed in the user interface. In one embodiment, the testing tool 128 verifies the validity of matrix scripts and executes the automation engine 100 to poll data remotely. It is possible for the testing tool 128 to be used as both a matrix scripts development assistance tool, and as a debug tool for the Matrix DLL.

Map for Looking Up Values

In one embodiment, the matrix analyzer component 108 includes functionality to add matrix variables and their values into a map. Also, the recipe processor component 116 can add processed recipes and their values into the map. The map can be used for looking up values before using the RPN module of the Matrix DLL.

Matrix Elements and Definitions

In one possible embodiment of the invention, a matrix contains the following elements as set out in Table 1 below.

TABLE 1
Possible Matrix Elements

| Element | Comment |
|---|---|
| Size of matrix | The size of the matrix is understood by those skilled |
| | in the art. |
| Name space | The name space element is a name of a category of |
| | WMI (or CIM) classes. The name space can be used |
| | when a connection is made to a machine. |
| Implementation | The implementation method element specifies the |
| method | implementation method in the monitoring automation |
| | engine. Possible methods include Query and |
| | Registry, and the implementation methods can be |
| | extensible. |
| | Inside a method, the same code can be used to |
| | implement different features. For example, more than |
| | one possible module can be implemented using a |
| | method called Query method. For the Query method, |
| | a WQL is generated to query information. Referring to |
| | FIG. 3, the controller 104 can call corresponding |
| | WMI implementation methods for every matrix and |
| | save data into a variable map (in one embodiment |
| | the dictionary collection class is CMapStringToOb). |
| | For the Registry method, methods of StdRegProv |
| | instead of WQL are used to collect the information |
| | from WMI. Three parameters of this method are: |
| | “hDefKey”, “sSubKeyName” and “sValueName”. So |
| | in the WMI matrix, the following rules are followed. |
| | (1) Namespace can be optional. |
| | (2) For Registry type, each matrix will have only three |
| | constraints. |
| | (3) The first constraint in the matrix will be “RootKey” |
| | value which corresponds to “hDefKey” parameter. |
| | (4) The second constraint in the matrix will be |
| | “SubKey” value which corresponds to |
| | “sSubKeyName” parameter. |
| | (5) The third constraint in the matrix will be “Method” |
| | value which specifies the class method that will be |
| | called. |
| | Usually the following methods of StdRegProv are |
| | used: “GetBinaryValue”, “GetDWORDValue”, |
| | “GetStringValue”, “GetMultiStringValue” |
| | (6) One “Variable” will be defined in the matrix which |
| | corresponds to the “sValueName” parameter. |
| WMI (or CIM) | The WMI (or CIM) class name element is the name of |
| class name | WMI (or CIM) class which is used to poll data. |
| Processing type | The processing type element specifies how to |
| | process data polled. Possible types include Value, |
| | Count, Sum, List and Compare. This aspect of |
| | processing is extensible. |
| Variable size | The variable size is understood by those skilled in the |
| | art. |
| Variable name | The variable element specifies which properties are |
| and property | to be collected. It is a pair of name and property. |
| | Name is used to uniquely identify a variable. |
| | Property is an attribute of a WMI (or CIM) class. |
| Constraint size | The constraint size is understood by those skilled in |
| | the art. |
| Constraint | The constraints element determines a subset of |
| parameter, value | instances meeting some conditions. Parameter and |
| and type | value forms a pair of constraint conditions. Types |
| | define how constraint conditions are logically |
| | combined. |
| Comparing lists | The comparing lists size is understood by those |
| size | skilled in the art. |
| Comparing items | The comparing items element specifies the |
| | inclusive/exclusive set operations for results |
| | collected. |
| Scan detail size | The scan detail size is understood by those skilled in |
| | the art. |
| Scan details | The scan details element specifies what to be |
| (name, recipe and | returned and how to process the final data. Recipes |
| type) | are defined to allow performing mathematical and |
| | logic operation on initial data. Types are defined for |
| | the data to be returned. |

WQL Generator

One way of having WQL generated is by the forming of a suitable string. The following is an example string template.

Select Var.0.Property, Var.1.Property from WMIClassName where Constraint.0.Para=Constraint.0.Value Constraint.1.Type Constraint.1.Para=Constraint.1.Value

(Note that Constraint.1.Type could be either And or Or.)

Take the following example of a WMI Matrix.
Matrix.MatrixSize=1
Matrix.0.NameSpace=root\cimv2
Matrix.0.ImpMethod=Query
Matrix.0.WMIClassName=Win32_LogicalDisk
Matrix.0.ProcessingType=Value
Matrix.0.VarSize=2
Matrix.0.Var.0.Property=FreeSpace
Matrix.0.Var.0.VarName=DiskFreeSpace
Matrix.0.Var.1.Property=Size
Matrix.0.Var.1.VarName=DiskSize
Matrix.0.ConstraintSize=2
Matrix.0.Constraint.0.Para=DriveType
Matrix.0.Constraint.0.Value=3
Matrix.0.Constraint.1.Para=Name
Matrix.0.Constraint.1.Value=“C:”
Matrix.0.ComparingSize=0

For this example, a WQL will be generated as follows.

Select FreeSpace, Size from Win32_LogicalDisk where DriveType=3 and Name=“C:”

Recipes and Reverse Polish Notation

Polish Notation is a format of writing operators in front of their operands instead of between them, where brackets are made unnecessary. Reverse Polish Notation (RPN) is a format that the operators follow the operands (postfix operators). RPN has the advantage that the operators appear in the order required for computation.

RPN is a simple and efficient method to express a sequence of calculations in a defined grammar without using parentheses to show which operation must be performed first. For example, the expression (2−3)*(4+5) would be written as 2 3−4 5+* in Reverse Polish Notation.

An RPN algorithm uses a stack to do the calculation. It traverses the expression in RPN format and processes each token (a number or an operator) as follows.

If the token is a number, then it is pushed into the stack.

If the token is an operator, then

1. two items are popped from the stack

2. the operator is applied to them

3. the result is pushed back into the stack.

It will be understood that a variety of different forms of recipes are possible; however in one embodiment recipes follow the following grammars in RPN format.

Recipe::=[Number|VariableName]

Recipe::=[Number|VariableName|Recipe][Number|VariableName|Recipe]Operator

Number: any valid integer or float number

VariableName: any name defined in matrix, such as a value defined in Matrix.0.Var.0.VarName. A variable name is prefixed with “$” in recipes.

Operator: four mathematical operators (+, −, *, /) and three logic operations (&, |, ˜) are allowed. This is extensible.

In a WMI framework, the recipes are WMI recipes. The WMI recipe is used to describe what kind of information needs to be obtained.

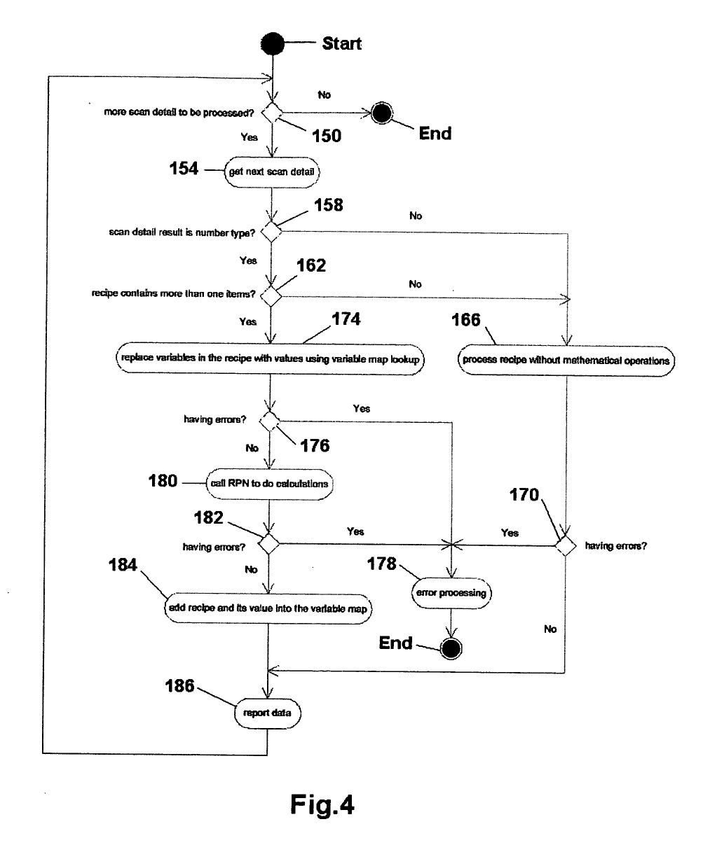

FIG. 4 is a flow chart illustrating an example method for the processing of the scan details and recipes. In the flow chart, steps 154, 166, 174, 178, 180, 184 and 186 are the action steps, and steps 150, 158, 162, 170, 176 and 182 are the decision steps.

At the step 150, it is determined whether more of the scan detail needs to be processed. If yes, the next scan detail is obtained (this is the step 154). If no, the processing is complete.

At the next step, which is the step 158, it is determined whether the scan detail result is a number type. If yes, it still needs be determined at the step 162 whether the recipe contains more than one item. Only if both the scan detail result is a number type and the recipe contains more than one item will the processing continue in accordance with the steps shown on the left portion of the flow chart, otherwise the recipe is processed in some other way without mathematical operations, and then an error check is done at the step 170 before the data is reported.

If both the scan detail result is a number type and the recipe contains more than one item, the next step is the step 174. At this step, the variables in the recipe are replaced with values using the variable map lookup. At the next step, which is the step 176, an error is check is done. If there are any errors, error processing is done at the step 178. If there are no errors, the next step is the step 180. Here the RPN module is called to do calculations. Next, an error check is done again at the step 182. If there are no errors, the recipe and its value are added into the variable map at the step 184. The data is reported at the step 186, which is the final step before a loop back to the step 150.

Compare Type

Referring to Table 1, processing type matrix element, data polled can be processed by the recipe process component 116 according to the Compare processing type. With respect to this processing type, a number of items from the central server are compared. It will be understood that the number of items compared and the size of each item compared is not essential; however in one embodiment up to five items can be compared and each item is of 8 K bytes at most. The Compare processing type contains comparing strings which can be separated by commas. The following is an example:

comparing string1,comparing string2,comparing string3

When a returning result is of Compare type, up to six parameters will be returned if up to five comparing items are allowed. The returned scan details can conveniently be original scan details with an appended number such as a number in the range of 0 to 5. For example, if the scan detail is MyScanDetail, then the scan detail returned to central server will be MyScanDetail0, MyScanDetail1, MyScanDetail2, MyScanDetail3, MyScanDetail4, MyScanDetail5. In one embodiment, the first scan detail is of Boolean type to indicate whether the strings queried from the universal WMI module 62 match the comparing strings or not. The other five scan details return the strings queried from the WMI module 62 but not in the comparing strings. The strings can be of VeryLongString type also, containing strings separated by commas.

In one embodiment, when a returning result is of Compare type, only one property in a matrix will be retrieved.

List Type

Referring again to Table 1, processing type matrix element, List is a possible type. When a returning result is of List type, action possibilities for the recipe processor component 116 can include: (1) Put matrix index (such as Matrix0) as recipe value in scan detail. Then all the variables in that matrix will be returned as a list of records. Every record contains all variables of that matrix for the same instance. (2) Put a variable name as recipe value in scan detail. Then all the instances of the variable will be returned in a string separated with commas.

Matrix Samples Using Standard WMI Classes

The example below is a matrix intended for an application compliance service.
Matrix.MatrixSize=1
Matrix.0.NameSpace=root\default
Matrix.0.ImpMethod=Registry
Matrix.0.WMIClassName=StdRegProv
Matrix.0.ProcessingType=Compare
Matrix.0.VarSize=1
Matrix.0.Var.0.Property=DisplayName
Matrix.0.Var.0.VarName=App
Matrix.0.ConstraintSize=3
Matrix.0.Constraint.0.Para=RootKey
Matrix.0.Constraint.0.Value=HKEY_LOCAL_MACHINE
Matrix.0.Constraint.1.Para=SubKey
Matrix.0.Constraint.1.Value=Software\Microsoft\Windows\CurrentVersion\Uninstall
Matrix.0.Constraint.2.Para=GetMethod
Matrix.0.Constraint.2.Value=GetStringValue
Matrix.0.ComparingSize=5
Matrix.0.Comparing.0=\\here the comparing value list is omitted
Matrix.0.Comparing.1=
Matrix.0.Comparing.2=
Matrix.0.Comparing.3=
Matrix.0.Comparing.4=
Scandetail.Size=1
Scandetail.0.Name=WMI_ACS_LIST
Scandetail.0.Recipe=$App
Scandetail.0.Type=Compare

Mathematical operations are defined by the matrix in the next example below.
Matrix.MatrixSize=1
Matrix.0.NameSpace=root\cimv2
Matrix.0.ImpMethod=Query
Matrix.0.WMIClassName=Win32_LogicalDisk
Matrix.0.ProcessingType=Value
Matrix.0.VarSize=2
Matrix.0.Var.0.Property=FreeSpace
Matrix.0.Var.0.VarName=DiskFreeSpace
Matrix.0.Var.1 Property=Size
Matrix.0.Var.1.VarName=DiskSize
Matrix.0.ConstraintSize=2
Matrix.0.Constraint.0.Para=DriveType
Matrix.0.Constraint.0.Value=3
Matrix.0.Constraint.1.Para=Name
Matrix.0.Constraint.1.Value=“C:”
Scandetail.Size=4
Scandetail.0.Name=USED_DISK_SPACE
Scandetail.0.Recipe=$DiskSize $DiskFreeSpace-
Scandetail.0.Type=uint64
Scandetail.1.Name=USED_DISK_SPACE_PERCENTAGE_FLOAT
Scandetail.1.Recipe=$DiskSize $DiskFreeSpace-$DiskSize/
Scandetail.1.Type=Float
Scandetail.2.Name=USED_DISK_SPACE_PERCENTAGE_INTEGER
Scandetail.2.Recipe=$USED_DISK SPACE_PERCENTAGE_FLOAT 100*
Scandetail.2.Type=Percentage
Scandetail.3.Name=USED_DISK_SPACE2
Scandetail.3.Recipe=$USED_DISK_SPACE
Scandetail.3.Type=uint64

Matrix Samples Using Non-Standard WMI Classes

The example below is a matrix intended for a Microsoft Exchange™ service.
Matrix.MatrixSize=4
Matrix.0.NameSpace=root\cimv2
Matrix.0.ImpMethod=Query
Matrix.0.WMIClassName=Win32_PerfRawData_MSExchangeIS_MSExchangeIS
Matrix.0.ProcessingType=Value
Matrix.0.VarSize=2
Matrix.0.Var.0.Property=ActiveUserCount
Matrix.0.Var.0.VarName=VarActiveUserCount
Matrix.0.Var.1.Property=RPCRequests
Matrix.0.Var.1.VarName=VarRPCRequests
Matrix.1.NameSpace=root\cimv2
Matrix.1.ImpMethod=Query
Matrix.1.WMIClassName=Win32_PerfRawData_MSExchangeIS_MSExchangeISMailbox
Matrix.1.ProcessingType=Value
Matrix.1.VarSize=2
Matrix.1.Var.0.Property=SendQueueSize
Matrix.1.Var.0.VarName=VarSendQueueSize
Matrix.1.Var.1.Property=ReceiveQueueSize
Matrix.1.Var.1.VarName=VarReceiveQueueSize
Matrix.2.NameSpace=root\cimv2
Matrix.2.ImpMethod=Query
Matrix.2.WMIClassName=CIM_DataFile
Matrix.2.ProcessingType=Sum
Matrix.2.VarSize=1
Matrix.2.Var.0.Property=FileSize
Matrix.2.Var.0.VarName=PublicInformationStoreFileSize
Matrix.2.ConstraintSize=2
Matrix.2.Constraint.0.Para=Name
Matrix.2.Constraint.0.Value=“c:\\Program
Files\\Exchsrvr\\MDBDATA\\pub1.edb”
Matrix.2.Constraint.0.Type=And
Matrix.2.Constraint.1.Para=Name
Matrix.2.Constraint.1.Value=“c:\\Program Files\\Exchsrvr\\MDBDATA\\pub1.stm”
Matrix.2.Constraint.1.Type=Or
Matrix.3.NameSpace=root\cimv2
Matrix.3.1 mpMethod=Query
Matrix.3.WMIClassName=CIM_DataFile
Matrix.3.ProcessingType=Sum
Matrix.3.VarSize=1
Matrix.3.Var.0.Property=FileSize
Matrix.3.Var.0.VarName=PrivateInformationStoreFileSize
Matrix.3.ConstraintSize=2
Matrix.3.Constraint.0.Para=Name
Matrix.3.Constraint.0.Value=“c:\\Program
Files\\Exchsrvr\MDBDATA\priv1.edb”
Matrix.3.Constraint.0.Type=And
Matrix.3.Constraint.1.Para=Name
Matrix.3.Constraint.1.Value=“c:\\Program
Files\\Exchsrvr\\MDBDATA\\priv1.stm”
Matrix.3.Constraint.1.Type=Or
Scandetail.Size=6
Scandetail.0.Name=MSX_USER_CNT
Scandetail.0.Recipe=$VarActiveUserCount
Scandetail.0.Type=uint32
Scandetail.1.Name=MSX_RPC_REQUEST
Scandetail.1.Recipe=$VarRPCRequests
Scandetail.1.Type=uint32
Scandetail.2.Name=MSX_SEND_QUEUE
Scandetail.2.Recipe=$VarSendQueueSize
Scandetail.2.Type=uint32
Scandetail.3.Name=MSX_RECV_QUEUE
Scandetail.3.Recipe=$VarReceiveQueueSize
Scandetail.3.Type=uint32
Scandetail.4.Name=MSX_PUB_SIZE
Scandetail.4.Recipe=$PublicInformationStoreFileSize
Scandetail.4.Type=uint64
Scandetail.5.Name=MSX_PRV_SIZE
Scandetail.5.Recipe=$PrivateInformationStoreFileSize
Scandetail.5.Type=uint64

A Terminal server service is what the matrix in the example below is intended for.
Matrix.MatrixSize=1
Matrix.0.NameSpace=root\cimv2
Matrix.0.ImpMethod=Query
Matrix.0.WMIClassName=Win32_PerfRawData_TermService_TerminalServices
Matrix.0.ProcessingType=Value
Matrix.0.VarSize=3
Matrix.0.Var.0.Property=ActiveSessions
Matrix.0.Var.0.VarName=VarActiveSessions
Matrix.0.Var.1.Property=InactiveSessions
Matrix.0.Var.1.VarName=VarInactiveSessions
Matrix.0.Var.2.Property=TotalSessions
Matrix.0.Var.2.VarName=VarTotalSessions
Scandetail.Size=3
Scandetail.0.Name=TSS_ACTIVESESSIONS
Scandetail.0.Recipe=$VarActiveSessions
Scandetail.0.Type=uint32
Scandetail.1.Name=TSS_INACTIVESESSIONS
Scandetail.1.Recipe=$VarInactiveSessions
Scandetail.1.Type=uint32
Scandetail.2.Name=TSS_TOTALSESSIONS
Scandetail.2.Recipe=$VarTotalSessions
Scandetail.2.Type=uint32

The example below is a matrix intended for an SQL server service.
Matrix.MatrixSize=3
Matrix.0.NameSpace=root\cimv2
Matrix.0.ImpMethod=Query
Matrix.0.WMIClassName=Win32_PerfRawData_MSSQLSERVER_SQLServerDatabases
Matrix.0.ProcessingType=Value
Matrix.0.VarSize=4
Matrix.0.Var.0.Property=ActiveTransactions
Matrix.0.Var.0.VarName=VarActiveTransactions
Matrix.0.Var.1.Property=LogFilesSizeKB
Matrix.0.Var.1.VarName=VarLogFileSizeKB
Matrix.0.Var.2.Property=DataFilesSizeKB
Matrix.0.Var.2.VarName=VarDataFileSizeKB
Matrix.0.Var.3.Property=TransactionsPersec
Matrix.0.Var.3.VarName=VarTransactionsPersec
Matrix.0.ConstraintSize=1
Matrix.0.Constraint.0.Para=Name
Matrix.0.Constraint.0.Value=“_Total”
Matrix.1.NameSpace=root\cimv2
Matrix.1.ImpMethod=Query
Matrix.1.WMIClassName=Win32_PerfRawData_MSSQLSERVER_SQLServerGeneral Statistics
Matrix.1.ProcessingType=Value
Matrix.1.VarSize=1
Matrix.1.Var.0.Property=UserConnections
Matrix.1.Var.0.VarName=VarUserConnections
Matrix.2.NameSpace=root\cimv2
Matrix.2.ImpMethod=Query
Matrix.2.WMIClassName=Win32_PerfRawData_MSSQLSERVER_SQLServerLocks
Matrix.2.ProcessingType=Value
Matrix.2.VarSize=2
Matrix.2.Var.0.Property=AverageWaitTimems
Matrix.2.Var.0.VarName=VarAverageWaitTimems
Matrix.2.Var.1.Property=NumberofDeadlocksPersec
Matrix.2.Var.1.VarName=VarNumberofDeadlocksPersec
Matrix.2.ConstraintSize=1
Matrix.2.Constraint.0.Para=Name
Matrix.2.Constraint.0.Value=“_Total”
Scandetail.Size=7
Scandetail.0.Name=SQL_ACTIVETRANS
Scandetail.0.Recipe=$VarActiveTransactions
Scandetail.0.Type=uint32
Scandetail.1.Name=SQL_LOGFILESIZE
Scandetail.1.Recipe=$VarLogFileSizeKB
Scandetail.1.Type=uint32
Scandetail.2.Name=SQL_DATAFILESIZE
Scandetail.2.Recipe=$VarDataFileSizeKB
Scandetail.2.Type=uint32
Scandetail.3.Name=SQL_TRANSPERSEC
Scandetail.3.Recipe=$VarTransactionsPersec
Scandetail.3.Type=uint32
Scandetail.4.Name=SQL_USERCONNECTIONS
Scandetail.4.Recipe=$VarUserConnections
Scandetail.4.Type=uint32
Scandetail.5.Name=SQL_AVGWAITTIME
Scandetail.5.Recipe=$VarAverageWaitTimems
Scandetail.5.Type=uint32
Scandetail.6.Name=SQL_DEADLOCKSPERSEC
Scandetail.6.Recipe=$VarNumberofDeadlocksPersec
Scandetail.6.Type=uint32

Preferably the monitoring automation engine can be easily integrated into stand-alone applications. An example of this could be an asset discovery stand-alone application, wherein this application defines all matrix information and passes them to the monitoring automation engine to process. Returned data would be reorganized into other formats and sent back to the central server using specific protocols. A testing tool which can verify validity of matrix scripts and execute monitoring automation engine to poll data remotely could be another example.

As mentioned, an appliance of a monitoring system can comprise a probe having the architecture shown in FIG. 2. In this case, the automation engine would normally be within the appliance.

Custom services (such as services related to application compliance, Microsoft Exchange, SQL, terminal server, Internet Information Server and Internet Security and Acceleration) can be developed based on the monitoring automation engine. Also, one skilled in the art will appreciate the possibility of developing an application that would provide a user friendly interface permitting users to conveniently input matrix scripts and load them into a monitoring system.

Thus, it is apparent that there has been provided in accordance with the invention an automation engine and method for providing an abstraction layer that fully satisfies the objects, aims and advantages set forth above. While the invention has been described in conjunction with illustrated embodiments thereof, it is evident that many alternatives, modifications and variations will be apparent to those skilled in the art in light of the foregoing description. Accordingly, it is intended to embrace all such alternatives, modifications and variations as fall within the spirit and broad scope of the invention.

What I claim as my invention:

1. A system for monitoring at least one constituent of a network, the system comprising:
an automation engine in communication with said constituent;
code written in a service description language, said code containing extractable information to permit said automation engine to obtain raw operation data nascent from said constituent; and
at least one module for processing said code and providing said extractable information to said automation engine.

2. A system as claimed in claim 1 wherein said raw data is processed by said automation engine.

3. A system as claimed in claim 2 wherein said automation engine includes a CIM based data collector component.

4. A system as claimed in claim 1 wherein said module is located at the network constituent.

5. A system as claimed in claim 1 further comprising a server at a remote management location and communication means permitting said server to transmit said code to said module.

6. A system as claimed in claim 5 wherein said communication means includes a network path, a controller and a task schedule component of a network monitoring system.

7. A system as claimed in claim 1 wherein said extractable information is matrix information.

8. A system as claimed in claim 1 further comprising an appliance, said monitored network constituent outside of said appliance, said automation engine within said appliance.

9. A system as claimed in claim 1 wherein said service description language is a universal description language.

10. A system as claimed in claim 1 wherein said automation engine includes a recipe processor component.

11. A system as claimed in claim 8 further comprising formatted service data produced at least in part by said recipe processor component.

12. A method for obtaining operation data comprising the steps of:
retrieving code written in a service description language;
extracting information from said code;
generating executable instructions from said information; and
using said instructions to obtain raw operation data, said raw data nascent from at least one network constituent.

13. A method as claimed in claim 12 wherein said code is retrieved from a database.

14. A method as claimed in claim 13 wherein said database is in a remote management location.

15. A method as claimed in claim 12 wherein a selected one of a CIM interface and a WMI interface is employed during the using step.

16. A method as claimed in claim 15 wherein the using step includes executing WQL queries.

17. A method as claimed in claim 12 further comprising the step of calling an implementation method before the step of generating instructions, and wherein said information is matrix information and a matrix element determines which implementation method is called.

18. A method for altering raw operation data nascent from a network constituent, the method comprising the steps of:
retrieving code written in a service description language;
extracting information from said code; and
formatting said raw data into formatted service data, said information used in directing the formatting.

19. A method as claimed in claim 18 wherein said code is retrieved from a database.

20. A method as claimed in claim 18 wherein said database is in a remote management location.

21. A method as claimed in claim 18 wherein said information is matrix information and includes scan details.

22. A method as claimed in claim 21 wherein said scan details includes at least one recipe and said recipe follows a grammar in Reverse Polish Notation.

23. A method as claimed in claim 21 wherein said matrix information further comprises a matrix element specifying how to process data polled.

24. An article of manufacture for a network monitoring system comprising:
at least one processor readable carrier including:
(i) executable instructions adapted for extracting information from code written in a service description language; and
(ii) software means defining an automation engine adapted for using said information to format raw operation data of at least one network constituent, obtained by a component of said monitoring system, into formatted service data.

25. An article of manufacture as claimed in claim 24 wherein said processor readable carrier further includes code written in a universal service description language.

26. An article of manufacture as claimed in claim 24 wherein said automation engine includes a recipe processor component for processing scan details and handling said service data.

27. An article of manufacture as claimed in claim 26 wherein recipes processed by said processor component follow grammars in Reverse Polish Notation.

28. An article of manufacture as claimed in claim 24 wherein said automation engine includes a matrix analyzer component.

29. An article of manufacture as claimed in claim 24 wherein said processor readable carrier is a selected one of a CD, CD-R, hard disk and random access memory.
